(19) United States
(12) Patent Application Publication
(10) Pub. No.: US 2011/0117324 A1
(43) Pub. Date: May 19, 2011

(54) MICRO PROTRUSION-DEPRESSION STRUCTURE AND METHOD FOR PRODUCING THE SAME

(75) Inventors: Koju ITO, Kanagawa (JP); Hidekazu YAMAZAKI, Kanagawa (JP)

(73) Assignee: FUJIFILM CORPORATION, Tokyo (JP)

(21) Appl. No.: 12/946,219

(22) Filed: Nov. 15, 2010

(30) Foreign Application Priority Data
Nov. 13, 2009 (JP) 2009-260139

(51) Int. Cl. B32B 3/30; B05D 3/02

(52) U.S. Cl. 428/158; 427/373

(57) ABSTRACT

A hydrophobic liquid containing a dispersion medium and fine particles is prepared. The fine particles have insolubility of a certain level in a predetermined liquid having a hydrophobic character. The hydrophobic liquid is applied to a support to be a film thereon. Wet gas is blown to the film. Water vapor is condensed from ambient air on a surface of the film to generate water drops thereon. A dispersion medium evaporating gas is blown to the film, such that the dispersion medium is evaporated from the film. A water drop evaporating gas is blown to the film, such that the water drops are evaporated from the film. Accordingly, the water drops function as the template for forming pores, such that the pores are formed on a micro protrusion-depression structure constituted by the fine particles.

### FIELD OF THE INVENTION

The present invention relates to a micro protrusion-depression structure which is constituted by an aggregation of fine particles and has a surface with micro protrusions and depressions, and a method for producing the micro protrusion-depression structure.

### BACKGROUND OF THE INVENTION

In recent years, increase in integration degree, higher information density, and higher image definition have been desired more and more in fields of optics and electronics. Therefore, a member used in these fields is required to have a finer structure on its surface. Namely, forming a fine pattern structure (hereinafter referred to as fine patterning) has been required. Additionally, in a field of research for a regenerative medicine, a member having a fine structure on its surface is effectively used as a scaffold for cell culture. Accordingly, the fine patterning has been required in various fields including not only the fields of optics and electronics but also the field of research for a regenerative medicine.

Various methods for the fine patterning have been put to practical use. For example, there are a deposition method using a mask, an optical lithography adopting photochemical reaction and polymerization reaction, a laser ablation technique, and the like. Additionally, as the fine patterning, there is known a method as follows. A primary body is formed from a solution obtained by dissolving a polymer into a solvent, and water drops are generated on the primary body. Then, the water drops are evaporated from the primary body. Upon the evaporation of the water drops, it is possible to obtain a polymer film having a plurality of pores made by using the water drops as a template for a porous structure on its surface. Such a method is disclosed in Japanese Patent Laid-Open Publications No. 2007-2241 and No. 2003-80538, for example.

According to the above-described methods, it is possible to produce a member having a surface with micro protrusions and depressions (hereinafter referred to as a micro protrusion-depression structure). In particular, according to Japanese Patent Laid-Open Publications No. 2007-2241 and No. 2003-80538, since a plurality of water drops are generated by condensation of water vapor, it is possible to achieve increase in processing accuracy and facilitate the production of the micro protrusion-depression structure, in comparison with the deposition method, the optical lithography, the laser ablation technique, and the like.

Such a micro protrusion-depression structure can be used in various fields. For example, the micro protrusion-depression structure can be used as an anti-reflection film or an anti-fingerprint film applied to an image display screen. In this case, the micro protrusion-depression structure is required to have resistance to a solvent, depending on the kind of detergent to be used for removing dirt from the film. Additionally, the micro protrusion-depression structure can be used as a highly-durable filter as described in Japanese Patent Laid-Open Publication No. 2003-80538 or a liquid-repellent film attached to a liquid ejection head of an ink jet or the like as described in U.S. Patent Application Publication No. 2007/0160790 (corresponding to Japanese Patent Laid-Open Publication No. 2007-175962). In this case, also, the micro protrusion-depression structure is required to have resistance to a solvent.

However, according to Japanese Patent Laid-Open Publication No. 2007-2241, it is necessary for the material of the micro protrusion-depression structure to have solubility in the solvent. Therefore, the method described in Japanese Patent Laid-Open Publication No. 2007-2241 is unsuitable for producing the micro protrusion-depression structure having resistance to a solvent. Additionally, according to Japanese Patent Laid-Open Publication No. 2003-80538, polyamic acid which is a polyimide precursor and soluble in the solvent is used to form a micro protrusion-depression structure, and then the micro protrusion-depression structure is subjected to imidation to produce a polyimide micro protrusion-depression structure having resistance to the solvent. Therefore, in the case of adopting the method described in Japanese Patent Laid-Open Publication No. 2003-80538, there is a limit to the materials for use as the material of the micro protrusion-depression structure, and consequently, there is a limit to the fields for adopting the produced micro protrusion-depression structure. Additionally, according to the method described in Japanese Patent Laid-Open Publication No. 2003-80538, it is necessary to subject polyamic acid to imidation and remove foreign substances generated in the process of imidation. Therefore, the production process of the micro protrusion-depression structure becomes complicated. Further, according to the method described in U.S. Patent Application Publication No. 2007/0160790 (corresponding to Japanese Patent Laid-Open Publication No. 2007-175962), fluorine coating for providing resistance to a solvent is necessary, and therefore there is a limit to the materials for use as the material of the micro protrusion-depression structure, as in the case of Japanese Patent Laid-Open Publication No. 2003-80538. Accordingly, although it is possible to produce the micro protrusion-depression structure having resistance to a solvent by the deposition method, the optical lithography, the laser ablation technique, or the like, it may be difficult to increase processing accuracy and to facilitate the production of the micro protrusion-depression structure.

### SUMMARY OF THE INVENTION

In view of the above, an object of the present invention is to provide a micro protrusion-depression structure having high resistance to a solvent, and a method for producing the micro protrusion-depression structure with ease and high accuracy.

In order to achieve the above and other objects, according to the present invention, a micro protrusion-depression structure comprises a plurality of fine particles having insolubility in a predetermined liquid having a hydrophobic character and a plurality of pores formed on a surface of an aggregation of the fine particles. A size of each of the fine particles is smaller than a size of each of the pores.

According to the present invention, a method for producing a micro protrusion-depression structure having a surface including a plurality of pores comprises a water drop generating step, a dispersion medium evaporating step, and a water drop evaporating step. In the water drop generating step, water drops as a template for forming the pores are generated on a liquid surface of a hydrophobic liquid containing a plurality of fine particles and a dispersion medium for the fine particles. A size of each of the fine particles is smaller than a size of each of the pores. In the dispersion medium evaporating step, the dispersion medium is evaporated from the hydrophobic liquid after the water drop generating step until movability of the fine particles has been disappeared. In the water drop evaporating step, the water drops are evaporated from the hydrophobic liquid in which movability of the fine particles has been disappeared.

It is preferable that a remaining amount of the dispersion medium in the hydrophobic liquid obtained by a formula expressed by (M1/M2)×100 is at most 50 mass % at the time of starting the water drop evaporating step. M1 is mass of the dispersion medium contained in the hydrophobic liquid, and M2 is mass of the fine particles contained in the hydrophobic liquid. Further, it is preferable that the hydrophobic liquid to be subjected to the water drop generating step contains the fine particles in a state of being dispersed.

It is preferable that the liquid surface of the hydrophobic liquid is a surface of a film formed from the hydrophobic liquid applied on a support.

Preferably, the hydrophobic liquid containing the fine particles in the state of being dispersed is applied to the support to form the film on the support before the water drop generating step, and then the film starts to be subjected to the water drop generating step within less than 10 minutes after the formation of the film. Further, interfacial tension between the hydrophobic liquid and water is preferably in the range of 5 mN/m or more to 25 mN/m or less.

According to the present invention, since the micro protrusion-depression structure is constituted by the aggregation of fine particles, it is possible to produce the micro protrusion-depression structure having resistance to the solvent. Further, the method of the present invention includes the water drop generating step, the dispersion medium evaporating step, and the water drop evaporating step. In the water drop generating step, the water drops as the template for forming the pores are generated on the surface of the film formed from the hydrophobic liquid containing the fine particles and the dispersion medium for the fine particles. In the dispersion medium evaporating step, the dispersion medium is evaporated from the film after the water drop generating step. In the water drop evaporating step, the water drops are evaporated from the film in which movability of the fine particles has been disappeared due to the dispersion medium evaporating step. Accordingly, the pores can exist stably in the micro protrusion-depression structure. In view of the above, according to the present invention, it is possible to produce the micro protrusion-depression structure having excellent resistance to the solvent with ease and high precision.

### DESCRIPTION OF THE DRAWINGS

One with ordinary skill in the art would easily understand the above-described objects and advantages of the present invention when the following detailed description is read with reference to the drawings attached hereto:

FIG. 1 is a plan view schematically illustrating a micro protrusion-depression structure having a plurality of pores on its surface according to a first embodiment of the present invention;

FIG. 2 is a cross sectional view taken along chain double-dashed lines II-II of FIG. 1 schematically illustrating the micro protrusion-depression structure according to the first embodiment;

FIG. 3 is an enlarged view of an area surrounded by a chain double-dashed line III in FIG. 1 schematically illustrating the micro protrusion-depression structure according to the first embodiment, and shows an end view of a surface of the micro protrusion-depression structure having the pores viewed in a normal direction.

FIG. 4 is an enlarged view of an area surrounded by a chain double-dashed line IV in FIG. 2 schematically illustrating the micro protrusion-depression structure according to the first embodiment.

FIG. 5 is a flow chart schematically illustrating a micro protrusion-depression structure producing method;

FIG. 6 is an explanatory view schematically illustrating a micro protrusion-depression structure producing apparatus;

FIG. 7 is a cross sectional view schematically illustrating a film in a film forming step;

FIG. 8 is a cross sectional view schematically illustrating the film in a water drop generating step;

FIG. 9 is a cross sectional view schematically illustrating the film in a water drop generating step;

FIG. 10 is a cross sectional view schematically illustrating the film in a dispersion medium evaporating step;

FIG. 11 is a cross sectional view schematically illustrating a primary body in a water drop evaporating step;

FIG. 12 is a cross sectional view schematically illustrating a micro protrusion-depression structure according to a second embodiment of the present invention;

FIG. 13 is a cross sectional view schematically illustrating a micro protrusion-depression structure according to a third embodiment of the present invention;

FIG. 14 is a cross sectional view schematically illustrating a micro protrusion-depression structure according to a fourth embodiment of the present invention; and

FIG. 15 is a cross sectional view schematically illustrating a micro protrusion-depression structure according to a fifth embodiment of the present invention.

### DESCRIPTION OF THE PREFERRED EMBODIMENTS

Hereinafter, preferred embodiments of the present invention are described in detail. However, the present invention is not limited thereto.

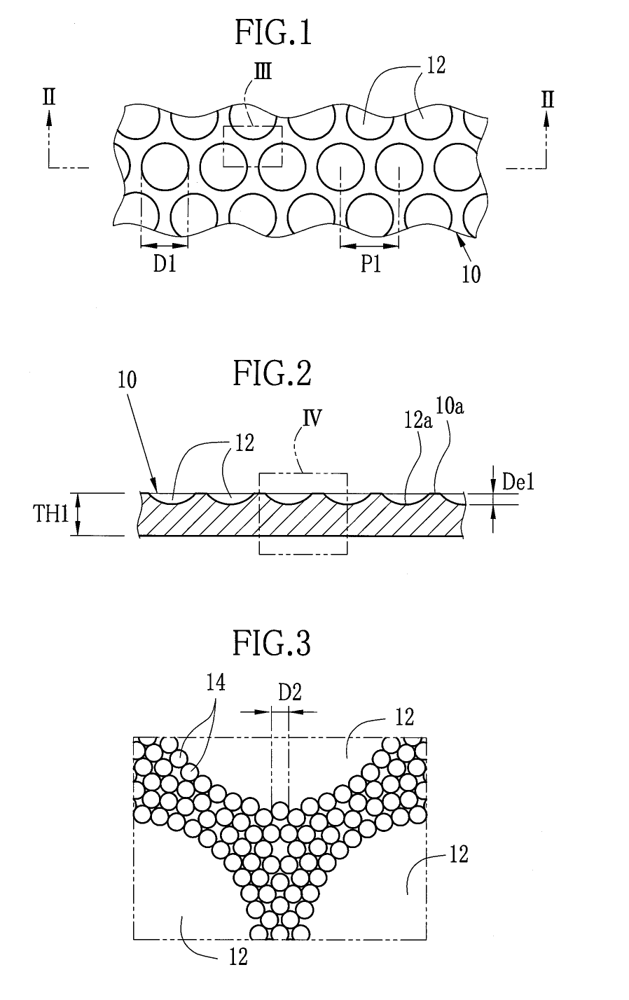

As shown in FIG. 1, a micro protrusion-depression structure 10 of the present invention is in the form of a sheet, and has a plurality of pores 12 on its surface. The pores 12 are densely arranged on the micro protrusion-depression structure 10 so as to constitute a so-called honeycomb structure.

Note that, in this specification, the honeycomb structure means a structure in which the pores each having a specific shape and size are arranged regularly in a specific direction as described above. In the honeycomb structure, basically, arbitrary one pore is surrounded by plural (for example, 6) pores on the same plane. The number of pores formed around the arbitrary one pore on the same plane is not limited to six, and may be three to five, or seven or more.

The size and formation density of the pores 12 vary depending on production conditions to be described later. Although the shape and size of the micro protrusion-depression structure 10 of the present invention is not especially limited, a thickness TH1 of the micro protrusion-depression structure 10 shown in FIG. 2 is preferably in the range of 0.05 μm or more to 10 μm or less, more preferably in the range of 0.05 μm or more to 5 μm or less, and most preferably in the range of 0.1 μm or more to 3 μm or less. Further, a diameter D1 of each of the pores 12 shown in FIG. 1 is preferably in the range of 0.05 μm or more to 3 μm or less, more preferably in the range of 0.1 μm or more to 2 μm or less, and most preferably in the range of 0.1 μm or more to 1 μm or less. A pitch P1 that is a distance between centers of the adjacent pores 12 as shown in FIG. 1 is preferably in the range of 0.1 μm or more to 10 μm or less, more preferably in the range of 0.1 μm or more to 5 μm or less, and most preferably in the range of 0.1 μm or more to 3 μm or less.

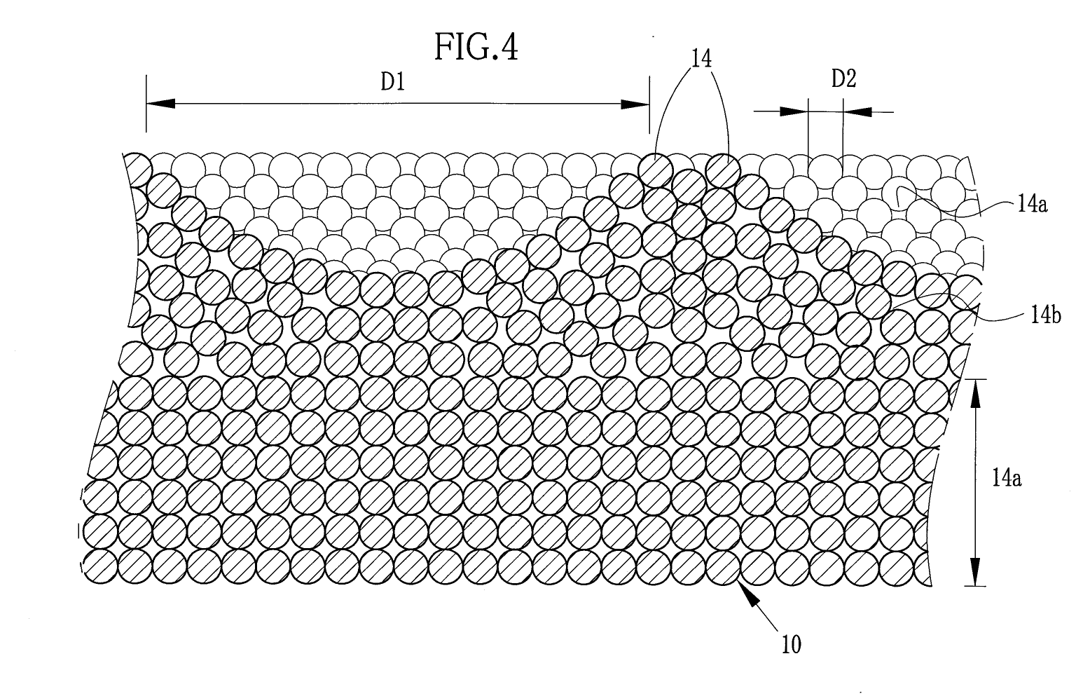

A depth from a surface 10a of the micro protrusion-depression structure 10 to a bottom 12a of the pore 12 is denoted by De1 as shown in FIGS. 2 and 4. The value obtained by dividing De1 by D1, De1/D1 is preferably in the range of 0.05 or more to 1.2 or less, and more preferably in the range of 0.2 or more to 1.0 or less. Note that, FIGS. 3, 4, and 7 to 11 are schematic views.

As shown in FIG. 3 and FIG. 4, the micro protrusion-depression structure 10 is constituted by an aggregation of fine particles 14. A diameter D2 of each of the fine particles 14 is smaller than the diameter D1 of each of the pores 12. The value obtained by dividing D1 by D2, D1/D2 is preferably in the range of 5 or more to 50,000 or less, and more preferably in the range of 10 or more to 10,000 or less. Further, the diameter D2 of each of the fine particles 14 is preferably in the range of 1 nm or more to 10 μm or less, more preferably in the range of 3 nm or more to 1 μm or less, and most preferably in the range of 5 nm or more to 0.1 μm or less.

The fine particles 14, which form the surface of the micro protrusion-depression structure 10 having the pores 12, are spherically arranged. For example, as shown in FIG. 4, the fine particles 14 are spherically arranged in the pore 12 on the surface of the micro protrusion-depression structure 10. The spherically-arranged fine particles 14 as described above have regularity at a certain level in some cases. For example, in the micro protrusion-depression structure 10 shown in FIG. 4, the plurality of fine particles 14 arranged so as to form pores 12 constitute regular arrangement parts 14a. In the regular arrangement parts 14a, the fine particles 14 are arranged in a zigzag manner.

Additionally, a portion deeper than the bottoms 12a of the pores 12 (see FIG. 2) in the thickness direction of the micro protrusion-depression structure 10 is also constituted by the regular arrangement parts 14a in which the fine particles 14 are arranged with regularity at a certain level in some cases. For example, in the regular arrangement part 14a which is located deeper than the bottoms 12a of the pores 12 of the micro protrusion-depression structure 10, as shown in FIG. 4, the plurality of fine particles 14 are arranged in a matrix manner. As described above, the regularity of the arrangement of the fine particles 14 in the regular arrangement parts 14a for forming the surface of the micro protrusion-depression structure 10 having the pores 12, and the regularity of the arrangement of the fine particles 14 in the regular arrangement parts 14a located in the portion deeper than the bottoms 12a of the pores 12 of the micro protrusion-depression structure 10 are not always equal to each other.

Further, in other cases, there are irregular arrangement parts 14b, in which the fine particles 14 are arranged without regularity, between the regular arrangement parts 14a for forming the surface of the micro protrusion-depression structure 10 having the pores 12 and the regular arrangement parts 14a located in the portion deeper than the bottoms 12a of the pores 12 of the micro protrusion-depression structure 10.

The arrangement of the fine particles 14 in the regular arrangement part 14a corresponds to an arrangement of atoms in a body-centered cubic structure, a face-centered cubic structure, a hexagonal close-packed structure, or other crystal structures. The arrangement of fine particles 14 in the irregular part 14b corresponds to an arrangement of atoms in a grain boundary.

Note that, the micro protrusion-depression structure 10 can obtain the resistance to a solvent regardless of the regular arrangement parts 14a and the irregular arrangement parts 14b.

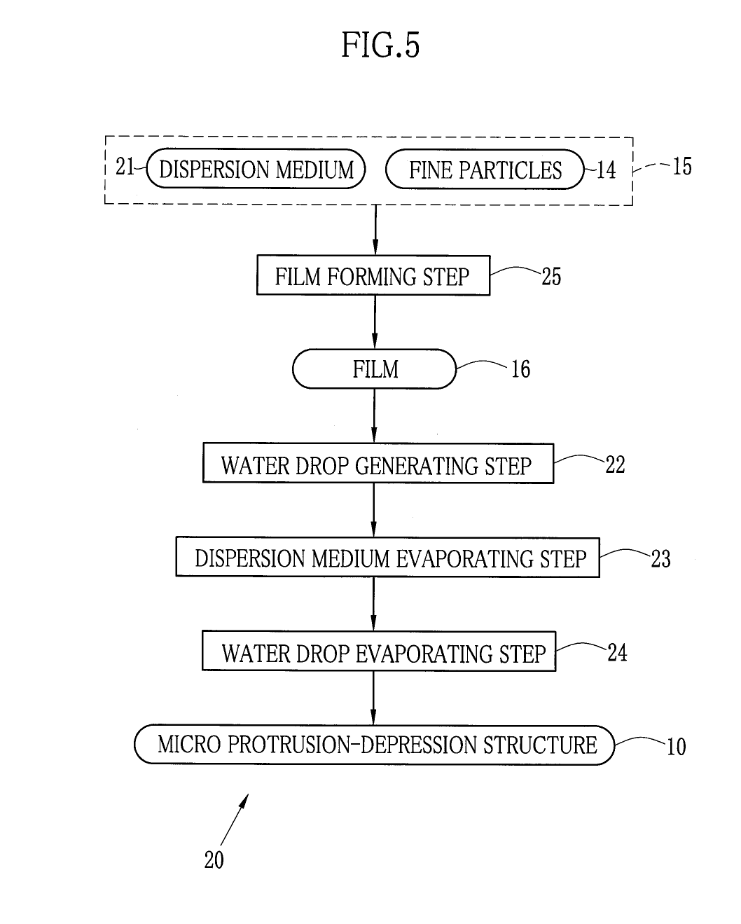

As shown in FIG. 5, in a micro protrusion-depression structure producing method 20, the micro protrusion-depression structure 10 is produced from a hydrophobic liquid 15 containing a dispersion medium 21 and the fine particles 14. The micro protrusion-depression structure producing method 20 includes a water drop generating step 22, a dispersion medium evaporating step 23, and a water drop evaporating step 24. In the water drop generating step 22, water drops to be used as a template for forming the pores 12 (see FIG. 1) are generated on a surface of a film 16 formed from the hydrophobic liquid 15. In the dispersion medium evaporating step 23, the dispersion medium 21 is evaporated from the film 16 after being subjected to the water drop generating step 22. In the water drop evaporating step 24, the water drops are evaporated from the film 16 after being subjected to the dispersion medium evaporating step 23. Note that, the micro protrusion-depression structure producing method 20 may include a film forming step 25 in which the film 16 is formed from the hydrophobic liquid 15. The film forming step 25 may be performed before the water drop generating step 22.

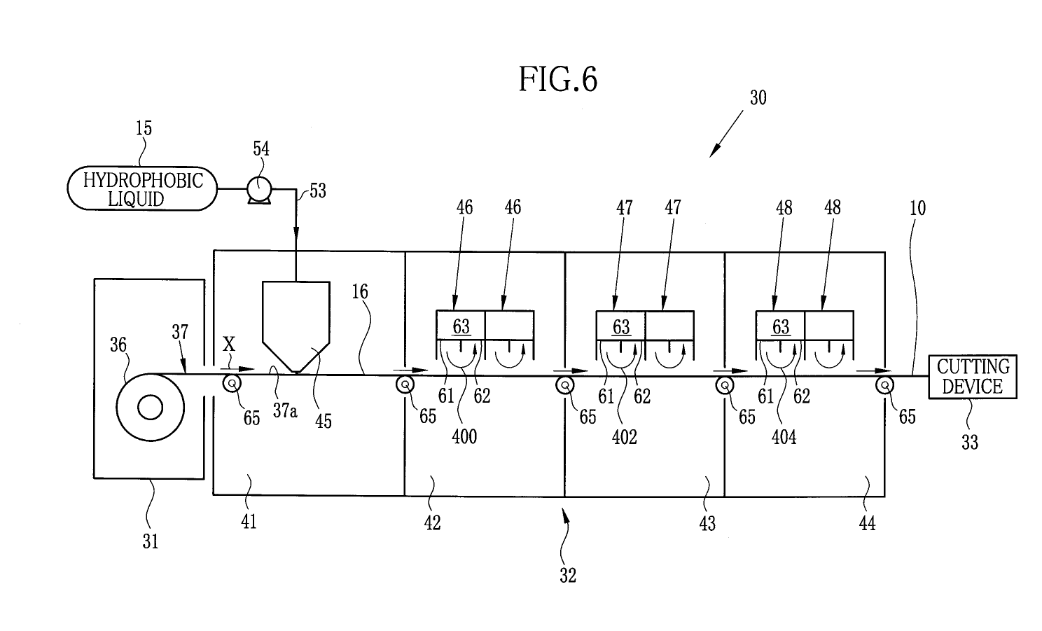

As shown in FIG. 6, a micro protrusion-depression structure producing apparatus 30 includes a support feeding device 31, a coating chamber 32, and a cutting device 33. The support feeding device 31 unwinds a support roll 36 to feed a support 37 in the form of a belt to the coating chamber 32. In the coating chamber 32, the micro protrusion-depression structure producing method 20 is performed, in which the hydrophobic liquid 15 is applied to the support 37, and the support 37 applied with the hydrophobic liquid 15 is subjected to given treatment, such that the micro protrusion-depression structure 10 is obtained. The obtained micro protrusion-depression structure 10 is cut together with the support 37 to have a predetermined size such that an intermediate product is obtained in the cutting device 33. The intermediate product is subjected to various kinds of processing to be a final product. The support 37 may be a stainless plate, a glass plate, or a polymer plate. Note that, the support feeding device 31 and the cutting device 33 are used in order to continuously produce a large number of micro protrusion-depression structures 10. Therefore, the support feeding device 31 and the cutting device 33 may be arbitrarily omitted depending on the production scale.

The coating chamber 32 is divided into 4 sections which are a first section 41 for performing the film forming step 25, a second section 42 for performing the water drop generating step 22, a third section 43 for performing the dispersion medium evaporating step 23, and a fourth section 44 for performing the water drop evaporating step 24 in this order from an upstream side in a moving direction of the support 37. Hereinafter, the moving direction of the support 37 is referred to as X direction. The first section 41 is provided with a coating die 45 for applying the hydrophobic liquid 15 to the support 37. The hydrophobic liquid 15 applied to the support 37 becomes the film 16 on the support 37. The second section 42 is provided with air feeding/sucking units 46 for feeding wet gas 400 to the film 16. The third section 43 is provided with air feeding/sucking units 47 for feeding a dispersion medium evaporating gas 402 to the film 16. The fourth section 44 is provided with air feeding/sucking units 48 for feeding a water drop evaporating gas 404 to the film 16.

The coating die 45 is provided with a slit (not shown) having a port (not shown). The slit is communicated with a tank (not shown) for storing the hydrophobic liquid 15 through a pipe 53. The pipe 53 is provided with a pump 54. The port of the slit is disposed in the coating die 45 so as to face the support 37. A distance between the port of the slit and a surface 37a of the support 37 is preferably adjusted within the range of 0.01 mm to 10 mm. Note that, the coating die 45 may be provided with a temperature adjuster (not shown) for adjusting the temperature of the hydrophobic liquid 15 which passes through the slit within a predetermined range or adjusting the temperature of each part of the coating die 45 such as the port of the slit and its periphery so as to prevent condensation on the coating die 45.

In the second section 42, two air feeding/sucking units 46 are arranged in series along the X direction. Each of the air feeding/sucking units 46 includes a duct having an outlet 61 and an inlet 62, and an air feeder 63. The air feeder 63 adjusts a temperature and a dew point of wet gas 400 and the flow volume of the wet gas 400 fed through the outlet 61. Each of the air feeding/sucking units 46 feeds the wet gas 400 through the outlet 61, and sucks gas around the film 16 through the inlet 62.

Two air feeding/sucking units 47 are arranged in series along the X direction in the third section 43, and two air feeding/sucking units 48 are arranged in series along the X direction in the fourth section 44. Each of the air feeding/sucking units 47 and 48 has the same structure as that of the air feeding/sucking units 46. Note that, the number of the air feeding/sucking units provided in the each of the sections 42 to 44 may be one, or three or more.

A plurality of rollers 65 are disposed arbitrarily in each of the sections 41 to 44. Main rollers 65 are shown in the drawing, and other rollers 65 are not shown. The rollers 65 include driving rollers and driven rollers, namely, free rollers. As the driving rollers are arbitrarily disposed, the support 37 is transported at a constant speed in each of the sections 41 to 44. The temperature of each of the rollers 65 is controlled by a temperature controller (not shown) in each of the sections 41 to 44. Additionally, a temperature adjusting plate (not shown) is disposed between the adjacent rollers 65 so as to be in proximate to a surface reverse to the surface 37a of the support 37. The temperature of the temperature adjusting plate is set such that the temperature of the surface 37a of the support 37 falls within a predetermined range.

A dispersion medium recovery device (not shown) is disposed in each of the sections 41 to 44 of the coating chamber 32 so as to recover the dispersion medium contained in the atmosphere in each of the sections 41 to 44. The recovered dispersion medium is refined in a refining device (not shown) to be reused.

Next, the micro protrusion-depression structure producing method 20 (see FIG. 5) performed in the micro protrusion-depression structure producing apparatus 30 is described hereinbelow. In the micro protrusion-depression structure producing apparatus 30, the rollers 65 are driven to rotate such that the support 37 is fed from the support feeding device 31 to the coating chamber 32. The temperature of the surface 37a of the support 37 is kept approximately constant within a predetermined range (within the range of 0° C. to 30° C.) by the not-shown temperature adjusting plate. The support 37 passes through the first section 41, the second section 42, the third section 43, and the fourth section 44 in this order at a predetermined speed (within a speed of 0.001 m/min to 100 m/min). The pump 54 is used to supply a prescribed amount of the hydrophobic liquid 15 adjusted at an approximately constant temperature within a predetermined range (within the range of 0° C. to 30° C.) from the tank to the coating die 45.

(Film Forming Step)

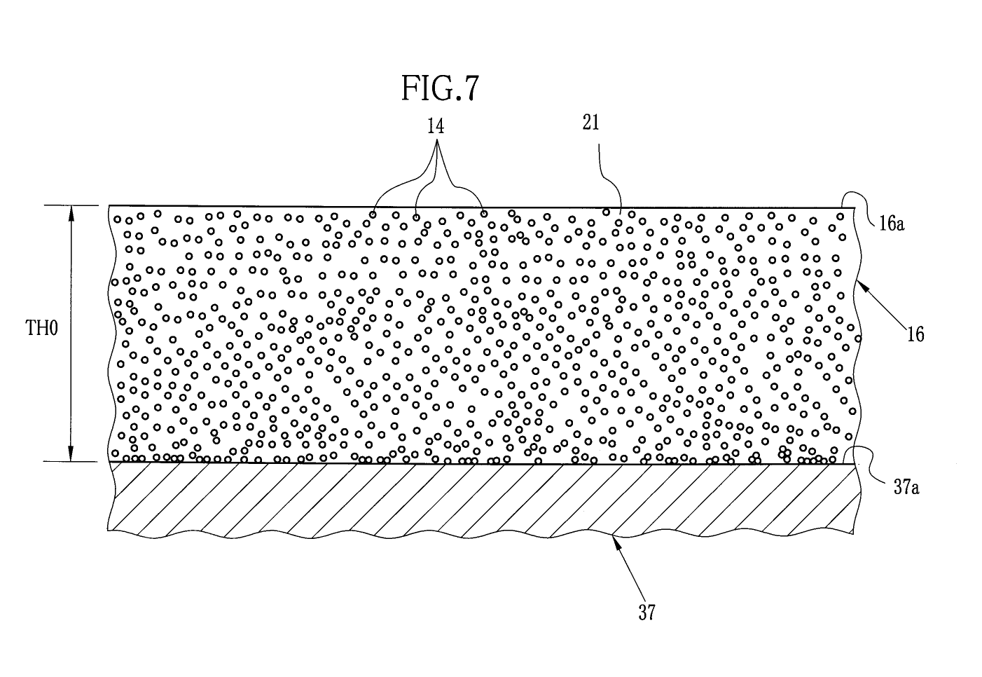

As shown in FIG. 6, in the first section 41, the hydrophobic liquid 15 is continuously applied to the surface 37a of the support 37 through the port of the slit of the coating die 45. Thus, the hydrophobic liquid 15 applied to the surface 37a of the support 37 becomes the film 16 thereon as shown in FIG. 7. The film 16 contains the fine particles 14 in the state of being dispersed.

A thickness TH0 of the film 16 (see FIG. 7) can be controlled by adjusting the viscosity and flow volume of the hydrophobic liquid 15, the clearance of the slit of the casting die 45 (see FIG. 6), the moving speed of the support 37, or the like. The thickness TH0 is preferably at most 400 μm, more preferably at most 200 μm, and most preferably at most 100 μm. Note that, in order to form the film 16 whose thickness TH0 is uniform, it is preferable that the thickness TH0 is set to be at least 10 μm.

(Water Drop Generating Step)

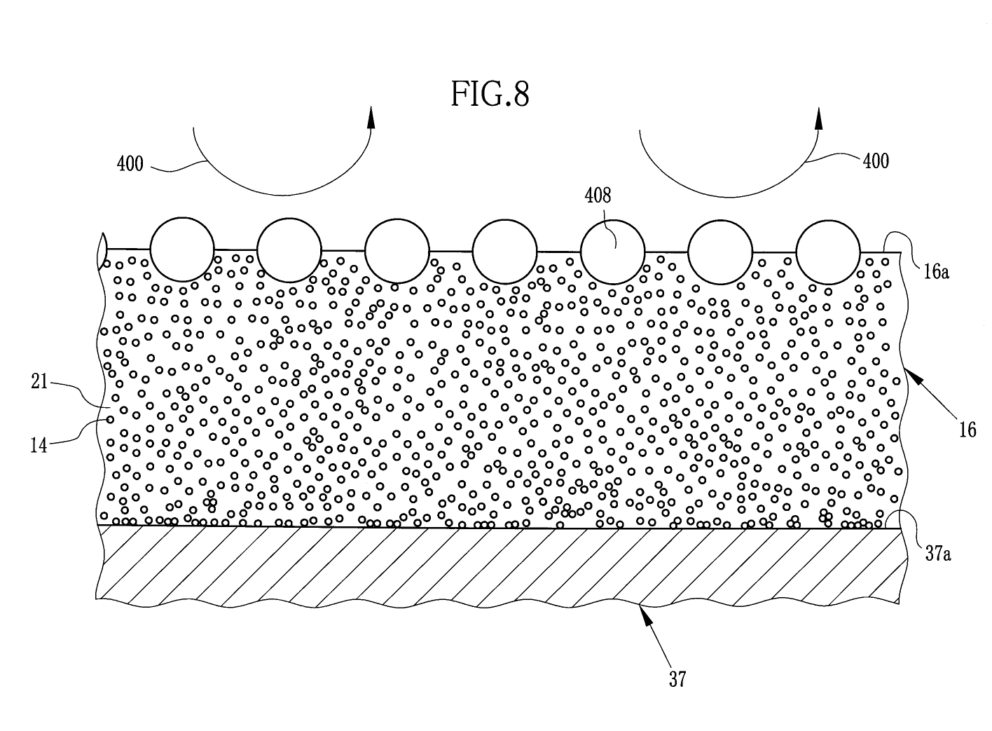

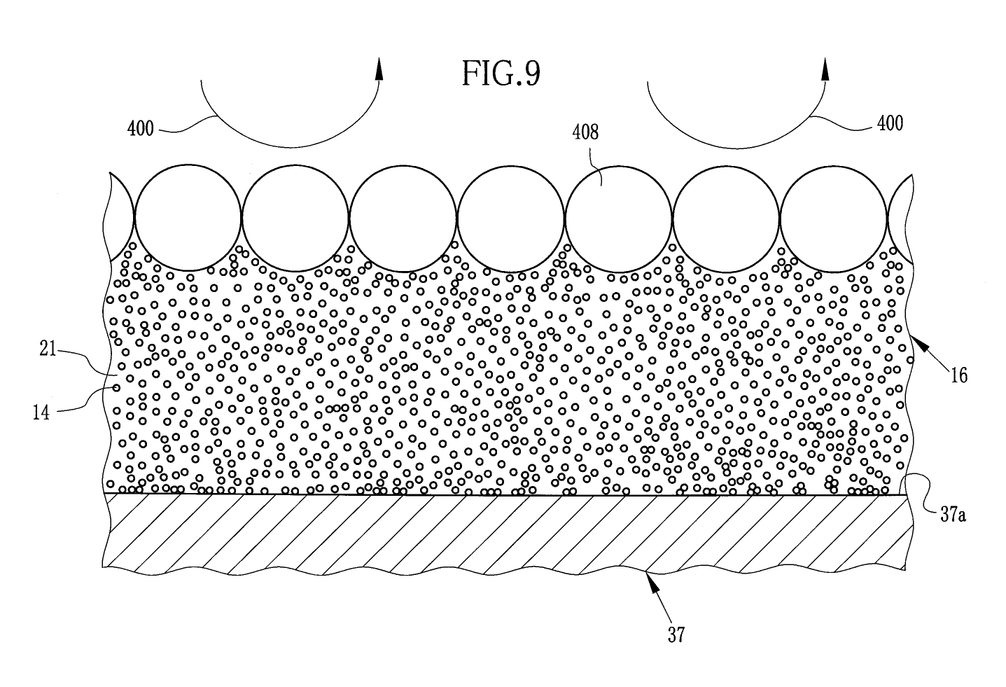

As shown in FIG. 6, the wet gas 400 is blown from the air feeding/sucking units 46 toward the film 16 in the second section 42. As shown in FIG. 8, upon contact of the wet gas 400 with the film 16, water vapor is condensed from ambient air on a surface 16a of the film 16. Thereby, water drops 408 are generated on the surface 16a of the film 16. Subsequently, upon contact of the wet gas 400 with the film 16 having the water drops 408 on its surface 16a, the water drops 408 are grown up, as shown in FIG. 9. Due to the capillary force and the like applied to the water drops 408, the arrangement of the water drops 408 on the surface 16a provides a honeycomb structure. Note that, the wet gas 400 is preferably continuously supplied to the film 16 until the diameter of each of the water drops 408 achieves a predetermined value.

The formation amount of cores of the water drops 408 or the growth degree of cores of the water drops 408 can be controlled by adjusting a parameter ΔTw₄₀₀(=TD₄₀₀−TS), which is obtained by subtracting a temperature TS of the surface 16a of the film 16 from a dew point TD₄₀₀ of the wet gas 400. The temperature TS can be adjusted by the temperature of the surface 37a of the support 37 or the temperature of the hydrophobic liquid 15. In order to condense water vapor from ambient air on the surface 16a of the film 16, the parameter ΔTw₄₀₀ in the second section 42 is preferably at least 0° C. Further, the parameter ΔTw₄₀₀ is preferably in the range of 0.5° C. or more to 30° C. or less, more preferably in the range of 1° C. or more to 25° C. or less, and most preferably in the range of 1° C. or more to 20° C. or less.

(Dispersion Medium Evaporating Step)

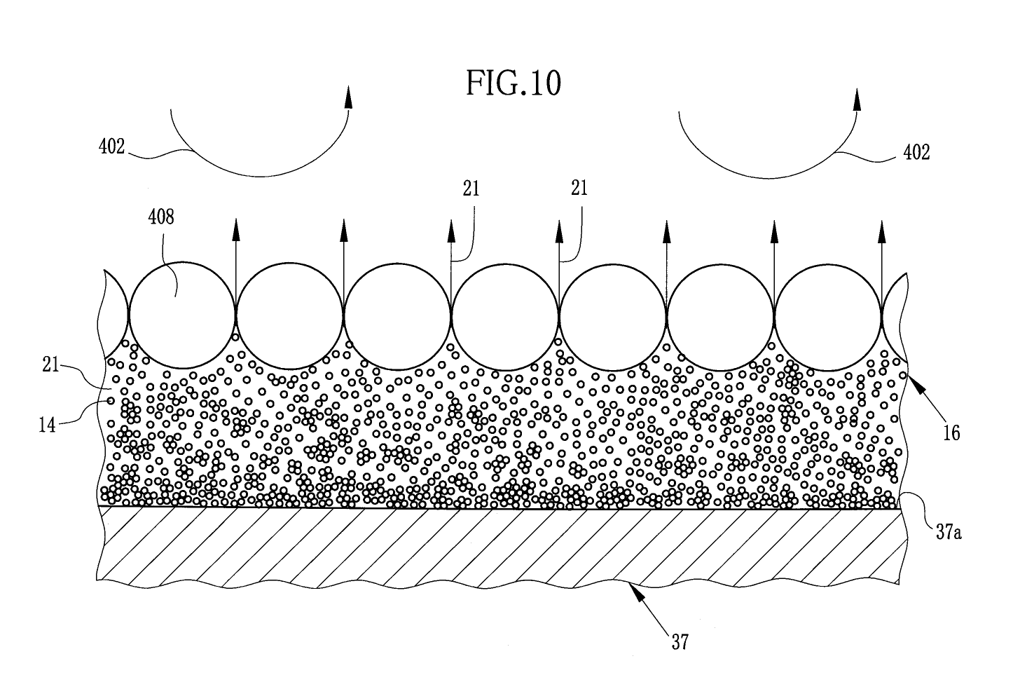

As shown in FIG. 6, the dispersion medium evaporating gas 402 is blown from the air feeding/sucking units 47 toward the film 16 in the third section 43. As shown in FIG. 10, upon contact of the dispersion medium evaporating gas 402 with the film 16, the dispersion medium 21 is evaporated from the hydrophobic liquid 15 for forming the film 16. Due to the evaporation of the dispersion medium 21, the fluidity of the hydrophobic liquid 15 for forming the film 16 is decreased, and the aggregation of the fine particles 14 contained in the hydrophobic liquid 15 is accelerated.

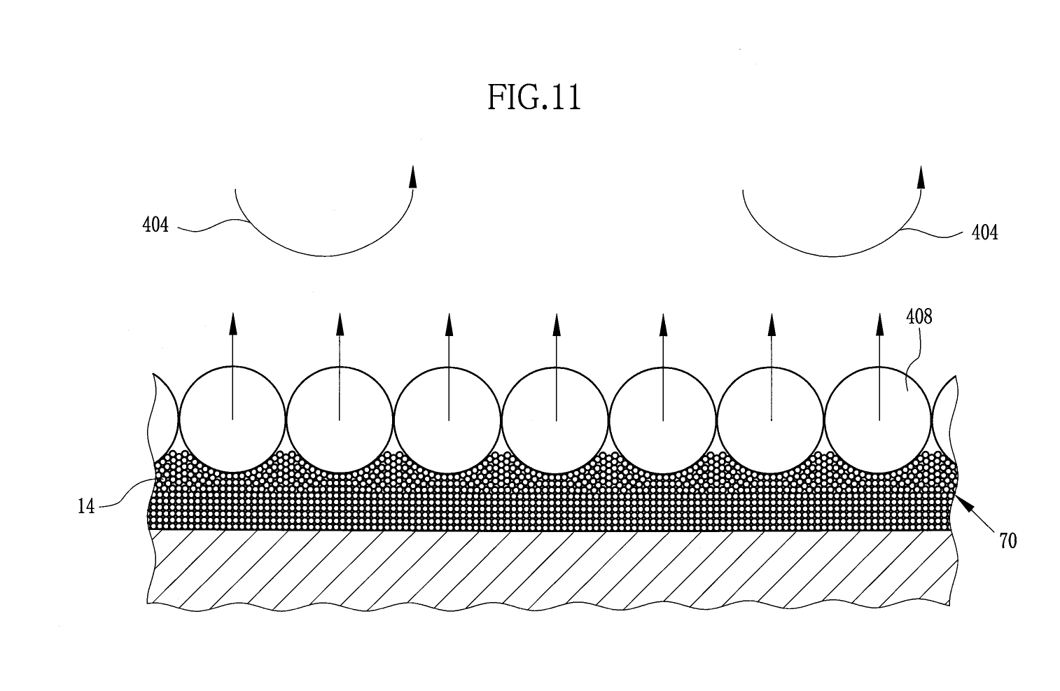

As shown in FIG. 11, the dispersion medium 21 is further evaporated, and thereby the fluidity of the hydrophobic liquid 15 for forming the film 16 is further decreased. The evaporation of the dispersion medium 21 is continued until the fluidity of the hydrophobic liquid 15 has been disappeared. When the fluidity of the hydrophobic liquid 15 has been disappeared, the movability of the fine particles 14 also has been disappeared. Here, in the state where “the movability of the fine particles 14 has been disappeared”, each of the fine particles 14 does not move (namely, movement of each of the fine particles 14 has been stopped), regardless of whether or not the dispersion medium 21 remains. As described above, since the evaporation of the dispersion medium 21 is continued until the movability of the fine particles 14 has been disappeared, the growth of the water drops 408 is stopped, and the film 16 becomes a primary body 70 of the micro protrusion-depression structure 10, which includes the water drops 408 as a template for forming the pores 12.

Further, in order to evaporate the dispersion medium 21 from the film 16, it is possible to adjust a parameter ΔTsolv(=TA−TR), which is obtained by subtracting a condensation point TR of the dispersion medium evaporating gas 402 from an atmospheric temperature TA around the film 16, within a predetermined range. Note that, the atmospheric temperature TA can be adjusted by the temperature of the dispersion medium evaporating gas 402. The condensation point TR can be adjusted by the dispersion medium recovery device (not shown). For example, ΔTsolv is preferably more than 0° C. Additionally, it is possible to accelerate the evaporation of the dispersion medium 21 from the film 16 by heating the film 16. The film 16 can be heated by heating the support 37. Note that, in the dispersion medium evaporating step 23, for the purpose of preventing evaporation of the water drops 408, a parameter ΔTw₄₀₂ (TD₄₀₂−TS), which is obtained by subtracting the surface temperature TS of the surface 16a of the film 16 from a dew point TD₄₀₂ of the dispersion medium evaporating gas 402, within the range of 0° C. to 10° C.

In the case where it is desired to judge whether or not the fluidity of the hydrophobic liquid 15 achieves a level for preventing the growth of the water drops 408, the viscosity and composition of the hydrophobic liquid 15, a remaining amount ZB of the dispersion medium 21 (hereinafter referred to as dispersion medium remaining amount ZB) in the hydrophobic liquid 15, and the like can be used as an indicator of the judgment. In particular, the viscosity of the hydrophobic liquid 15 and the dispersion medium remaining amount ZB can be preferably used as the indicator of the judgment. The range of the viscosity of the hydrophobic liquid 15 and the range of the dispersion medium remaining amount ZB for judging whether or not the fluidity of the hydrophobic liquid 15 achieves the level for preventing the growth of the water drops 408 vary depending on the composition of the hydrophobic liquid 15 and the like. For example, the wet gas 400 is preferably caused to continuously contact with the hydrophobic liquid 15, until the viscosity of the hydrophobic liquid 15 becomes 10 Pa·s or more, or the dispersion medium remaining amount ZB in the hydrophobic liquid 15 becomes 500 wt % or less, such that the size of each of the water drops 408 achieves a target value. Here, the dispersion medium remaining amount ZB is the remaining amount of the dispersion medium 21 in the hydrophobic liquid 15 or the film 16 on a dry basis, and obtained by a formula expressed by (M1/M2)×100, in which M1 is mass of the dispersion medium 21 and M2 is mass of the fine particles 14 contained in the hydrophobic liquid 15 or the film 16. The dispersion medium remaining amount ZB can be calculated by a formula expressed by [(x−y)/y]×100, in which x is the weight of a sampling liquid or a sampling film at the time of sampling, and y is the weight of the same after being dried up. The sampling liquid or the sampling film is taken from a target liquid or a target film.

(Water Drop Evaporating Step)

As shown in FIG. 6, the water drop evaporating gas 404 is blown from the air feeding/sucking units 48 toward the film 16 in the fourth section 44. As shown in FIG. 11, upon contact of the water drop evaporating gas 404 with the film 16, the water drops 408 are evaporated from the film 16. Due to the evaporation of the water drops 408, the primary body 70 becomes the micro protrusion-depression structure 10 including the pores 12 which are made by using the water drops 408 as the template for forming the pores 12.

According to the present invention, the film 16 in which the movability of the fine particles 14 has been disappeared is subjected to the water drop evaporating step 24. Here, “the movability of the fine particles 14” is attributed to the fluidity of the dispersion medium 21 contained in the hydrophobic liquid 15 and intermolecular force between the fine particles 14 contained in the hydrophobic liquid 15. “The disappearance of the movability of the fine particles 14” is attributed to decrease in content of the dispersion medium 21 in the hydrophobic liquid 15. Note that, “the disappearance of the movability of the fine particles 14” includes a state that the movability of the fine particles 14 is at a level capable of keeping the shape of the pores 12 in the film 16 after being subjected to the water drop evaporating step 24, while the movability of the fine particles 14 remains. “The movability of the fine particles 14” is evaluated by using the dispersion medium remaining amount ZB as an indicator. For example, the water drop evaporating step 24 is preferably applied to the film 16 in which the dispersion medium remaining amount ZB is at most 50 wt %, and more preferably applied to the film 16 in which the dispersion medium remaining amount ZB is at most 30 wt %.

Accordingly, the dispersion medium evaporating step 23 is preferably continued until the movability of the fine particles 14 is disappeared. For example, the dispersion medium evaporating step 23 is preferably continued until the dispersion medium remaining amount ZB in the film 16 is decreased to at most 50 wt %, and more preferably continued until the dispersion medium remaining amount ZB in the film 16 is decreased to at most 30 wt %.

Thus, during or after the water drop evaporating step 24, the fine particles 14 for constituting the micro protrusion-depression structure 10 become difficult to move, and therefore the pores 12 to be formed by the arrangement of the fine particles 14 can exist stably in the micro protrusion-depression structure 10.

Further, according to the present invention, the film 16 containing the fine particles 14 in the state of being dispersed is subjected to the water drop generating step 22, and then sequentially subjected to the dispersion medium evaporating step 23 and the water drop evaporating step 24. As a result, finally, the water drops 408 function as the template for forming the pores 12, such that the pores 12 are formed. Here, “the film 16 containing the fine particles 14 in the state being dispersed” includes the film 16 in which all the fine particles 14 are dispersed, and the film 16 in which some of the fine particles 14 are dispersed and others are deposited. For example, the water drop generating step 22 preferably starts to be applied to the film 16 within less than 10 minutes after the formation of the film 16 in the film forming step 25, more preferably within less than 5 minutes after the formation of the film 16 in the film forming step 25, and most preferably within less than 3 minutes after the formation of the film 16 in the film forming step 25.

Note that, in the case where all or most of the fine particles 14 contained in the hydrophobic liquid 15 for forming the film 16 are deposited, even if the dispersion medium evaporating step 23 is applied to the film 16, it is difficult for the water drops 408 to function as the template for forming the pores 12. In this case, it is preferable that a re-dispersion step for dispersing the deposited fine particles 14 again is performed between the water drop generating step 22 and a dispersion medium evaporating step 23. Thereby, it becomes possible to subject the film 16 containing the fine particles 14 in the state of being dispersed to the dispersion medium evaporating step 23.

In the re-dispersion step, the film 16 is heated through the support 37, or ultrasonic wave is irradiated to the film 16, for example. In the former case, the film 16 is heated through the support 37 such that there arises a difference in temperature between the surfaces of the film 16. Thereby, convection of the hydrophobic liquid 15 in the film 16 becomes activated. Due to the convection of the hydrophobic liquid 15, the deposited fine particles 14 are dispersed again. In the re-dispersion step, the aggregation of the fine particles 14 may be released, instead of dispersing the deposited fine particles 14 again.

In order to form the film 16 containing the fine particles 14 in the state of being dispersed, the hydrophobic liquid 15 containing the fine particles 14 in the state of being dispersed is preferably used. The hydrophobic liquid 15 containing the fine particles 14 in the state of being dispersed means the hydrophobic liquid 15 in which the fine particles 14 are dispersed uniformly.

Although the film forming step 25 is performed in the first section 41 and the water drop generating step 22 is performed in the second section 42 sequentially in the above embodiment, the present invention is not limited thereto. The film forming step 25 and the water drop generating step 22 may be performed at the same time. For example, the air feeding/sucking units 46 can be used in the first section 41 so as to fill the first section 41 with the wet air 400, such that the hydrophobic liquid 15 is applied to the support 37 in the first section 41 filled with the wet gas 400. Thereby, the film forming step 25 and the water drop generating step 22 can be performed at the same time. Since the film forming step 25 and the water drop generating step 22 are performed at the same time, it is possible to generate the water drops 408 before all the fine particles 14 are deposited. Thus, the pores 12 can be formed surely.

Note that, in order to increase binding force between the fine particles 14 for constituting the micro protrusion-depression structure 10, a binding force increasing step is preferably applied to the micro protrusion-depression structure 10 which is obtained by subjecting the primary body 70 to the water drop evaporating step 24. The binding force increasing step is not especially limited as long as it is possible to increase the binding force between the fine particles 14 for constituting the micro protrusion-depression structure 10. As the binding force increasing step, for example, there is fusion bonding of the fine particles 14. As a method for performing the fusion bonding of the fine particles 14, the micro protrusion-depression structure 10 is heated, or vapor is caused to contact with the micro protrusion-depression structure 10 to heat the micro protrusion-depression structure 10.

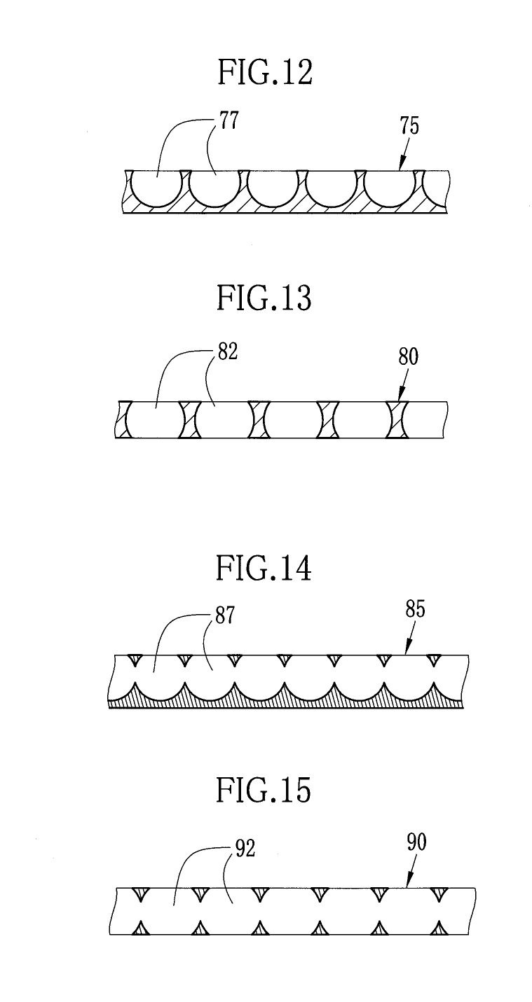

Note that, a micro protrusion-depression structure 75 having a plurality of pores 77 as shown in FIG. 12 is also applicable to the present invention. Further, a micro protrusion-depression structure 80 in which a plurality of pores 82 are formed so as to penetrate both surfaces of the micro protrusion-depression structure 80 as shown in FIG. 13 is also applicable to the present invention. A micro protrusion-depression structure 85 in which adjacent pores 87 are interconnected with each other as shown in FIG. 14 is also applicable to the present invention. Furthermore, a micro protrusion-depression structure 90 in which a plurality of pores 92 are formed so as to penetrate both surfaces of the micro protrusion-depression structure 90 and the adjacent pores 92 are interconnected with each other as shown in FIG. 15 is also applicable to the present invention.

Note that, the micro protrusion-depression structure of the present invention may be in the form of a block having the pores 12 on its surface. In order to produce the micro protrusion-depression structure in the form of a block, the hydrophobic liquid 15 is poured into a predetermined mold, and then the hydrophobic liquid stored in the mold is sequentially subjected to the water drop generating step 22, the dispersion medium evaporating step 23, and the water drop evaporating step 24.

Although the coating die is used for application of the hydrophobic liquid in the above embodiment, the present invention is not limited thereto. Well-known coating methods such as slide coating, gravure coating, bar coating, and roller coating also may be utilized in the present invention.

Although the wet air is used as the wet gas 400 in the above embodiment, the present invention is not limited thereto. Instead of the air, any one of nitrogen and rare gas may be used, or a mixed gas including at least one of air, nitrogen, and rare gas may be used. Similarly, although given air is used as the dispersion medium evaporating gas 402 or the water drop evaporating gas 404 in the above embodiment, the present invention is not limited thereto. Instead of the air, any one of nitrogen and rare gas may be used, or a mixed gas including at least one of air, nitrogen, and rare gas may be used.

Although the micro protrusion-depression structure 10 is cut together with the support 37 into a predetermined size in the cutting device 33 as shown in FIG. 6 in the above embodiment, the present invention is not limited thereto. For example, in the case where the support 37 moves continuously to pass sequentially the first section 41 to the fourth section 44 like an endless belt or drum made by stainless and other polymer films, the micro protrusion-depression structure 10 may be peeled from the support 37 and then introduced to the cutting device 33. Further, in the case of low volume production, instead of the support 37 in the form of a belt, a support in the form of a cut sheet may be used. Furthermore, the produced micro protrusion-depression structure 10 may be wound around a winding shaft. In this case, a thick portion which protrudes from the surface of the micro protrusion-depression structure 10 is preferably formed such that portions having the micro protrusions and depressions do not contact other portions of the wound micro protrusion-depression structure 10. Although the position for forming the thick portion may be arbitrarily set, the position for forming the thick portion is preferably located around the micro protrusions and depressions, for example. Further, in the case where the micro protrusion-depression structure 10 is in the form of a belt, the thick portion is preferably formed on both side edges of the micro protrusion-depression structure 10 in the width direction thereof. Furthermore, the thick portion may be formed on one or both of the surfaces of the micro protrusion-depression structure 10.

(Hydrophobic Liquid)

The hydrophobic liquid 15 contains the hydrophobic dispersion medium 21 and the fine particles 14 which are dispersed in the dispersion medium 21. The hydrophobic liquid 15 containing the dispersion medium 21 and the fine particles 14 is preferably homogeneous. A mass concentration of the fine particles 14 in the hydrophobic liquid 15 is sufficient as long as it is possible to form the film 16 having a uniform thickness on the surface 37a of the support 37. For example, the mass concentration of the fine particles 14 in the hydrophobic liquid 15 is preferably in the range of 0.01 mass % or more to 30 mass % or less. The fine particles 14 having the mass concentration of less than 0.01 mass % may be unsuitable for industrial mass production, because the productivity of the micro protrusion-depression structure 10 becomes low in some cases. In contrast, the fine particles 14 having the mass concentration of more than 30 mass % is not preferable, because the viscosity of the hydrophobic liquid 15 is too high and makes it difficult to form the film 16 having a uniform thickness.

The viscosity of the hydrophobic liquid 15 is preferably in the range of 1×10⁻⁴ Pa·s or more to 10 Pa·s or less. In the case where the viscosity of the hydrophobic liquid 15 is more than 10 Pa·s, it becomes difficult to arrange the water drops 408 on the film 16 due to the low fluidity of the hydrophobic liquid 15, and thereby variation in the pitch of the pores 12 unfavorably occurs. In contrast, in the case where the viscosity of the hydrophobic liquid 15 is less than 1×10⁻⁴ Pa·s, the high fluidity of the hydrophobic liquid 15 results in formation of water drops 408 interconnected with each other. Thereby, variation in the diameter of the pores 12 unfavorably occurs.

Interfacial tension between the hydrophobic liquid 15 and water is preferably in the range of 5 mN/m or more to 25 mN/m or less. When the interfacial tension between the hydrophobic liquid 15 and water is more than 25 mN/m, it becomes difficult to generate minute water drops on a liquid surface of the hydrophobic liquid 15, unfavorably, in some cases. In contrast, when the interfacial tension between the hydrophobic liquid 15 and water is less than 5 mN/m, the water drops 408 are fused with each other while being grown up, and thereby variation in the diameter of the pores 12 unfavorably occurs in some cases. The interfacial tension between the hydrophobic liquid 15 and water can be measured by a pendant drop method. In the pendant drop, water is pushed into a narrow tube immersed in the hydrophobic liquid, and the shape of the water drop pushed out from the tube is analyzed. In order to analyze the shape of the water drop, for example, “DropMaster Series DM-300” manufactured by KYOWA INTERFACE SCIENCE CO., LTD can be used.

(Dispersion Medium)

The dispersion medium 21 is preferably a hydrophobic liquid. The dispersion medium 21 may be dichloromethane, chloroform, toluene, pentane, n-hexane, cyclohexane, heptane, and octane, for example. Further, hydrophilic dispersion medium such as alcohol and ketone may be added to the dispersion medium having hydrophobic character. The additional amount of the hydrophilic dispersion medium is preferably at most 10 wt %. One of the above-described dispersion media or a mixture of a plurality of the above-described dispersion media can be used in the present invention.

As the dispersion medium 21 for use in the present invention, in addition to the above dispersion media, there may be used aromatic hydrocarbon (such as benzene and toluene), halogenated hydrocarbon (such as dichloromethane, chlorobenzene, and carbon tetrachloride, 1-bromopropane), aliphatic hydrocarbon which is in a liquid state at room temperature (such as pentane, n-hexane, cyclohexane, heptane, and octane), ketone (such as acetone and methyl ethyl ketone), esther (such as methyl acetate, ethyl acetate, and propyl acetate), and ether (such as tetrahydrofuran and methyl cellosolve), for example. A mixture of two or more compounds described above may be used as the dispersion medium. Further, hydrophilic solvent such as alcohol and ketone may be added to the single compound or the mixture of two or more compounds. Note that, the additional amount of the hydrophilic solvent is as low as at most 20% of the total amount of the single compound or the mixture of two or more compounds. Furthermore, in the case where no dichloromethane is used for the purpose of reducing adverse influence on the environment to the minimum, ether having 4 to 12 carbon atoms, ketone having 3 to 12 carbon atoms, ester having 3 to 12 carbon atoms, or bromine-containing hydrocarbon such as 1-bromopropane is preferably used. A mixture of them may be used. For example, a mixed organic solvent containing methyl acetate, acetone, ethanol, and n-butanol may be used. Note that, ether, ketone, ester, and alcohol may have a cyclic structure. A compound having at least two functional groups thereof (that is, —O—, —CO—, —COO—, and —OH) may be used as the dispersion medium. At least two different compounds are used as the dispersion medium, and the composition ratio of the compounds is arbitrarily changed. Thus, it becomes possible to keep the dispersed state of the fine particles in the dispersion medium, stabilize the water drops generated due to the condensation and used as the template for forming the pores, and control the productivity of the micro protrusion-depression structure 10.

(Fine Particles)

It is necessary for the fine particles 14 to have insolubility in a predetermined liquid having a hydrophobic character used under the usage environment (condition) of the micro protrusion-depression structure 10, such that the micro protrusion-depression structure 10 has desired resistance to the solvent. Additionally, in order to produce the micro protrusion-depression structure 10 using the hydrophobic liquid 15 containing the fine particles 14 in the state of being dispersed, it is necessary for the fine particles 14 to have insolubility in the dispersion medium 21 contained in the hydrophobic liquid 15. Here, the predetermined liquid having a hydrophobic character may be the same or different from the dispersion medium 21. As described above, the insolubility of the fine particles 14 in the micro protrusion-depression structure 10 of the present invention includes not only the case where the fine particles 14 are not dissolved into the liquid having the hydrophobic character at all, but also the case where the fine particles 14 are hard to be dissolved into the liquid having the hydrophobic character. The insolubility of a certain level of the fine particles 14 in the micro protrusion-depression structure 10 is preferably decided in view of both of the hours of use of the micro protrusion-depression structure 10 and the solubility of the fine particles 14 under the usage environment (condition) of the micro protrusion-depression structure 10. For example, when it is assumed that the hours of use of the micro protrusion-depression structure 10 in contact with the predetermined liquid having the hydrophobic character is 100 hours, the fine particles 14 may satisfy a condition in which the solubility of the fine particles 14 is kept lower than a predetermined level for at least 100 hours. Furthermore, in the case where it is assumed that the micro protrusion-depression structure 10 has contact with water under the usage environment thereof, in view of the insolubility of a certain level of the fine particles 14 in the water, the fine particles 14 may satisfy a condition in which the solubility of the fine particles 14 is kept lower than a predetermined level for hours of use of the micro protrusion-depression structure 10 in contact with the water.

The fine particles 14 may be, for example, inorganic fine particles (such as metal fine particles including pt, Au, Ag, and Cu, semiconductor fine particles including Si, Ge, ZnSe, CdS, ZnO, GaAs, InP, GaN, SiC, SiGe, and CuInSe₂, and metal oxide fine particles including TiO₂, SnO₂, SiO₂, and ITO), hydrophilic polymer fine particles, hydrophobic polymer fine particles having insolubility in the dispersion medium, nanocrystal of low-molecular organic compound having insolubility in the dispersion medium, and the like.

Note that, the micro protrusion-depression structure of the present invention may be constituted by an aggregation of fine particles of the same material or an aggregation of fine particles of different materials.

(Binder)

As the binder for the fine particles, polymer can be used. As the polymer, the polymer having hydrophobic character (hereinafter referred to as hydrophobic polymer) is preferably used. Additionally, surfactant can be used together with the hydrophobic polymer.

(Hydrophobic Polymer)

The hydrophobic polymer is not especially limited, and may be appropriately selected among publicly known hydrophobic polymers in accordance with the purpose. Examples of the hydrophobic polymers are vinyl-type polymer (for example, polyethylene, polypropylene, polystyrene, polyacrylate, polymethacrylate, polyacrylamide, polymethacrylamide, polyvinyl chloride, polyvinylidene chloride, polyvinylidene fluoride, polyhexafluoropropene, polyvinyl ether, polyvinyl carbazol, polyvinyl acetate, polytetrafluoroethylene, and the like), polyesters (for example, polyethylene terephthalate, polyethylene naphthalate, polyethylene succinate, polybutylene succinate, polylactic acid, and the like), polylactone (for example, polycaprolactone and the like), polyamide or polyimide (for example, nylon, polyamic acid, and the like), polyurethane, polyurea, polybutadiene, polycarbonate, polyaromatics, polysulfone, polyethersulfone, polysiloxane derivative, cellulose acylate (for example, triacetyl cellulose, cellulose acetate propionate, cellulose acetate butyrate, and the like), and the like. These may be used in the form of homo polymer, and otherwise used as copolymer or polymer blend as necessary, in view of solubility, optical physical properties, electric physical properties, film strength, elasticity, and the like. Note that, these polymers may be used in the form of mixture containing two or more kinds of polymers as necessary. The polymers for optical purpose are preferably cellulose acylate, cyclic polyolefin, and the like, for example.

(Surfactant)

The surfactant is not especially limited, and appropriately selected in accordance with the purpose. For example, there are an amphiphilic polymer which has a main chain of polyacrylamide, a hydrophobic side chain of dodecyl group, and a hydrophilic side chain of carboxyl group, a block copolymer of polyethylene glycol/polypropylene glycol, and the like. Additionally, the surfactant may be phospholipid, nonionic surfactant, or surface-active fine particles.

(Purpose)

The micro protrusion-depression structure of the present invention can be used as an antireflection film, an anti-fingerprint film, a filter as a material of a cell membrane or an optical material, a liquid-repellent film attached to a liquid ejection head of an ink jet, or the like.

### EXAMPLE

### Experiment 1

The micro protrusion-depression structure producing method 20 shown in FIG. 5 was performed in the micro protrusion-depression structure producing apparatus 30 shown in FIG. 6 to produce the micro protrusion-depression structure 10.

(Hydrophobic Liquid)

In Experiment 1, the hydrophobic liquid 15 having the following composition was used. Interfacial tension P between the hydrophobic liquid 15 and water was 15 mN/m.

| | |
|---|---|
| Fine particles 14 (SiO₂(silica)) | 5 pts. mass |
| Dispersion medium 21(chloroform) | 94.9 pts. mass |
| Additive (amphiphilicpolyacrylamide) | 0.1 pts. mass |

The hydrophobic liquid 15 was applied to the support 37 to be the film 16 thereon in the first section 41. The film 16 immediately after being formed had a thickness of 300 μm. In the second section 42, the wet gas 400 was applied to the film 16 at the timing when one minute has elapsed after the formation of the film 16, such that the water drops 408 were generated on the surface 16a of the film 16. In the third section 43, the dispersion medium evaporating gas 402 was blown to the film 16, such that the dispersion medium 21 was evaporated from the film 16. In the fourth section 44, the water drop evaporating gas 404 was blown to the film 16 in which the dispersion medium remaining amount ZB became 1 wt %, such that the water drops 408 were evaporated from the film 16. Accordingly, the micro protrusion-depression structure 10 was produced.

### Experiments 2 to 8

In Experiments 2 to 8, the micro protrusion-depression structure 10 was produced in the same manner as Experiment 1 except that the dispersion medium remaining amount ZB in the film 16 to which the water drop evaporating gas 404 was blown, an amount of time T1 required immediately after the formation of the film 16 until the blowing of the wet gas 400 to the film 16, and the interfacial tension P between the hydrophobic liquid 15 and water were set to values shown in Table 1. Note that, in Experiment 4, the micro protrusion-depression structure 10 was produced in the same manner as Experiment 1 except that the amount of amphiphilic polyacrylamide was set to 0.001 pts. mass, and the amount of the chloroform was set to 94.999 pts. mass.

TABLE 1

| | | | | Evaluation | |
|---|---|---|---|---|---|
| | ZB | T1 | P | Result | |
| | (wt %) | (minute) | (mN/m) | 1 | 2 |
| Experiment 1 | 1 | 1 | 15 | A | A |
| Experiment 2 | 5 | 1 | 15 | A | A |
| Experiment 3 | 30 | 5 | 15 | B | A |
| Experiment 4 | 50 | 3 | 15 | B | A |
| Experiment 5 | 5 | 10 | 15 | C | B |
| Experiment 6 | 5 | 1 | 28 | B | C |
| Experiment 7 | 100 | 1 | 15 | D | E |
| Experiment 8 | 200 | 30 | 15 | D | E |

Table 1 shows the dispersion medium remaining amount ZB in the film 16 to which the water drop evaporating gas 404 started to be blown, the amount of time T1 required immediately after the formation of the film 16 until the blowing of the wet gas 400 to the film 16, the interfacial tension P between the hydrophobic liquid 15 and the water, and an evaluation result of each evaluation item in Experiments 1 to 8. The numbers assigned to the evaluation results in Table 1 show the numbers assigned to the following evaluation items.

In Experiments 7 and 8, at the timing when the water drop evaporating gas 404 started to be blown to the film 16, the dispersion medium remaining amount ZB in the film 16 was still large as shown in Table 1. At the timing when the dispersion medium remaining amount ZB in the film 16 was still large as described above, the movability of the fine particles 14 has not been disappeared yet.

(Evaluation)

The micro protrusion-depression structure 10 obtained in Experiments 1 to 8 was evaluated as follows.

1. Evaluation of micro protrusions and depressions

The diameter D1 of each of the pores 12 in the micro protrusion-depression structure 10 and the depth De1 from the surface 10a of the micro protrusion-depression structure 10 to the bottom 12a of the pore 12 were measured, and the value obtained by dividing De1 by D1, De1/D1 was calculated. Evaluation was made for the calculated value of De1/D1 in each of Experiments 1 to 8 based on the following criteria.

A: Value of De1/D1 was in the range of 0.5 or more to 1.2 or less.

B: Value of De1/D1 was in the range of 0.2 or more to less than 0.5.

C: Value of De1/D1 was in the range of 0.05 or more to less than 0.2.

D: Value of De1/D1 was less than 0.05.

2. Evaluation of regularity of micro protrusions and depressions

Pores in an area of 120 μm long and 90 μm wide in an optical micrograph of the surface of the micro protrusion-depression structure 10 obtained in each of Experiments 1 to 8 was subjected to image analysis. The magnitude of the optical micrograph was 2500 times. The diameter of each of the pores was measured, and an average Dₐᵥ of pore diameters, a standard deviation σD of pore diameters, and a pore diameter variation coefficient X (unit: %) were calculated. The pore diameter variation coefficient X was determined as {(σD)/(Dₐᵥ)}×100. The pore diameter variation coefficient X was evaluated based on the following criteria.

A: Pore diameter variation coefficient X was 5% or less.

B: Pore diameter variation coefficient X was in the range of more than 5% to 10% or less.

C: Pore diameter variation coefficient X was in the range of more than 10% to 15% or less.

D: Pore diameter variation coefficient X was more than 15%.

E: Pore diameter variation coefficient X could not be calculated since no micro protrusions and depressions were observed.

Various changes and modifications are possible in the present invention and may be understood to be within the present invention.

What is claimed is:

1. A micro protrusion-depression structure comprising:
a plurality of fine particles having insolubility in a predetermined liquid having a hydrophobic character; and
a plurality of pores formed on a surface of an aggregation of said fine particles, a size of each of said fine particles being smaller than a size of each of said pores.

2. A method for producing a micro protrusion-depression structure having a surface including a plurality of pores, said method comprising the steps of:
(A) generating water drops as a template for forming said pores on a liquid surface of a hydrophobic liquid containing a plurality of fine particles and a dispersion medium for said fine particles, a size of each of said fine particles being smaller than a size of each of said pores;
(B) evaporating said dispersion medium from said hydrophobic liquid after the step A until movability of said fine particles has been disappeared; and
(C) evaporating said water drops from said hydrophobic liquid in which the movability of said fine particles has been disappeared.

3. A method according to claim 2, wherein a remaining amount of said dispersion medium in said hydrophobic liquid obtained by a formula expressed by (M1/M2)×100 is at most 50 mass % at the time of starting the step C, M1 being mass of said dispersion medium contained in said hydrophobic liquid and M2 being mass of said fine particles contained in said hydrophobic liquid.

4. A method according to claim 2, wherein said hydrophobic liquid to be subjected to the step A contains said fine particles in a state of being dispersed.

5. A method according to claim 2, wherein the liquid surface of said hydrophobic liquid is a surface of a film formed from said hydrophobic liquid applied on a support.

6. A method according to claim 5, wherein said hydrophobic liquid containing said fine particles in the state of being dispersed is applied to said support to form said film on said support before the step A, and then said film starts to be subjected to the step A within less than 10 minutes after the formation of said film.

7. A method according to claim 3, wherein interfacial tension between said hydrophobic liquid and water is in the range of 5 mN/m or more to 25 mN/m or less.
